(19) United States
(12) Patent Application Publication
(10) Pub. No.: US 2005/0282004 A1
(43) Pub. Date: Dec. 22, 2005

(54) Shock-absorbing strip for winding around handle

(76) Inventor: Leo Jaw, Taichung County (TW)

Correspondence Address: BACON & THOMAS, PLLC, 625 SLATERS LANE, FOURTH FLOOR, ALEXANDRIA, VA, 22314, US

(21) Appl. No.: 10/913,413

(22) Filed: Aug. 9, 2004

(30) Foreign Application Priority Data
Jun. 18, 2004 (TW) 93209687

(51) Int. Cl. B32B 27/04

(52) U.S. Cl. 428/354; 442/67

(57) ABSTRACT

A shock-absorbing strip for winding around the handle of a sports apparatus includes a base layer and a polyurethane layer bonded to the base layer. The base layer is formed of a resin-impregnated cloth for providing a supporting strength to the polyurethane layer and a firmly connecting strength between the base layer and the polyurethane layer.

### BACKGROUND OF THE INVENTION

1. Field of the Invention

The present invention relates to a strip for winding around the handle of a racquet or the like and more particularly, to a shock-absorbing strip that absorb shocks and has a high tensile strength.

2. Description of the Related Art

FIG. 1 discloses a conventional shock-absorbing strip, which is substantially identical to the disclosure of U.S. Pat. No. 5,695,418, for wrapping about the handle of a tennis racquet so as to form a grip on the handle for holding by a user. The shock-absorbing strip comprises a base layer 1 and a polyurethane layer 2. The base layer 1 is made by felt having a bottom surface for bonding to the periphery of the handle. The polyurethane layer 2 has a bottom surface bonded to the top surface of the base layer 1. Further, the polyurethane layer 2 provides a cushioning effect for the grip when the tennis racquet impacts a tennis ball. The polyurethane layer 2 also provides tackiness so as to inhibit the racquet user's hand from slippage as the tennis ball is struck. The base layer 1 provides a tensile strength superior to the polyurethane layer 2, for enabling the shock-absorbing strip to be rightly wrapped about the racquet handle.

However, because the base layer 1 has burrs on the surface, the polyurethane layer 2 may easily be forced away from the base layer 1. The loosen peripheral edge of the base layer 1 tends to break when the user stretching the shock-absorbing strip and wrapping the shock-absorbing strip about the racquet handle, thereby lowering the structural strength of the grip formed by the shock-absorbing strip.

### SUMMARY OF THE INVENTION

The present invention has been accomplished under the circumstances in view. It is the primary objective of the present invention to provide a shock-absorbing strip for winding around the handle of a sports apparatus, which has a high tensile strength.

To achieve this objective of the present invention, the shock-absorbing strip comprises a base layer and a polyurethane layer bonded to the base layer. The base layer is a resin-impregnated cloth formed of a cloth dipped with a resin such that the polyurethane layer can be firmly bonded to the base layer.

### BRIEF DESCRIPTION OF THE DRAWINGS

FIG. 1 is a sectional view of a shock-absorbing strip according to the prior art.

FIG. 2 is an exploded view in section of a shock-absorbing strip according to a preferred embodiment of the present invention.

FIG. 3 is a sectional view of the preferred embodiment of the present invention.

FIG. 4 is an applied view of the present invention showing the shock-absorbing strip wrapped about the handle of a racquet.

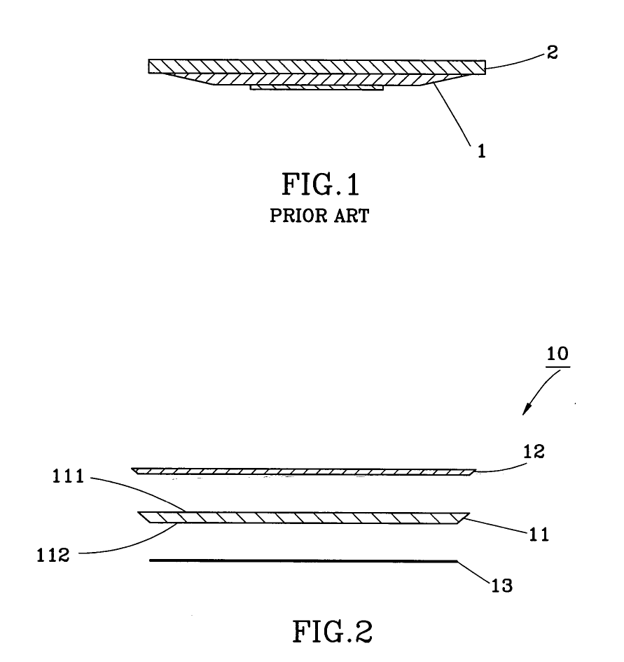

### DETAILED DESCRIPTION OF THE INVENTION

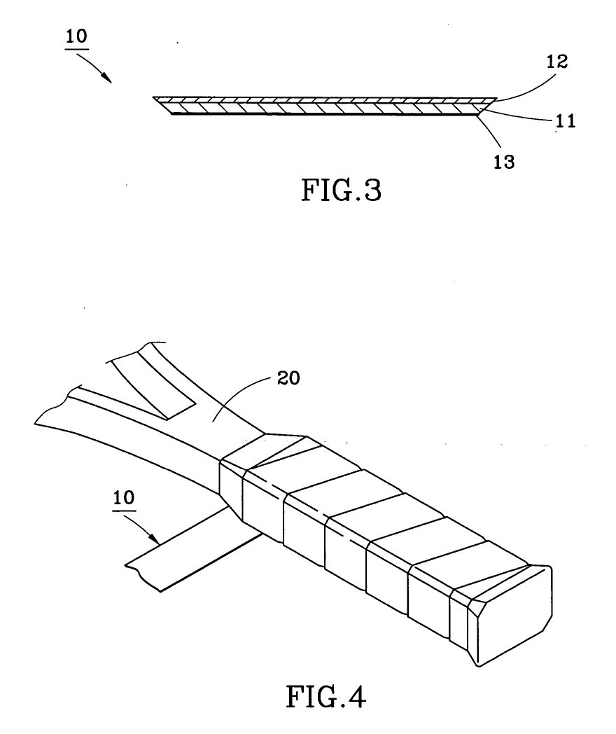

Referring to FIGS. 2 and 3, a shock-absorbing strip 10 provided by the present invention is a narrow elongated strip member having a base layer 11, a polyurethane layer 12, and a bonding layer 13.

The base layer 11 is a resin-impregnated cloth formed of a cloth, e.g. a non-woven fabric, dipped with a resin. The base layer 11 has a top surface 111 and a bottom surface 112. Bonding of resin to cloth greatly reinforces the structural strength of the base layer 11 and improves the bonding effect of coating. When the resin-impregnated cloth is cut to a desired size, the cutting edge is maintained smooth without burrs. Therefore, the base layer 11 can conveniently cut to the desired size. Because the cutting edge is maintained smooth without burrs, the base layer 11 does not split from the edge. Further, the resin used can be polyurethane resin or acrylic resin. Preferably, polyurethane resin is used.

The polyurethane layer 12 is processed through a foaming process and bonded to the top surface Ill of the base layer 11, having inside enclosed pores (not shown) that effectively improve shock-absorbing effect.

The bonding layer 13 is a layer of adhesive, e.g. a double-sided adhesive tape, covered on the bottom surface 112 of the base layer 11 for securing the base layer 11 to the surface of the handle of a sports apparatus.

Referring to FIG. 4, the strip 10 is wrapped about the surface of a racket's handle 20, keeping the bonding layer 13 bonded to the surface of the racket's handle 20. Because the bonding layer 13 fixedly secures the bottom surface 112 of the base layer 11 to the periphery of the racket's handle 20, the strip 10 does not slip on the surface of the racket handle 20. It is to be understood that glue can be used instead of the bonding layer for securing the strip to the handle, i.e. the bonding layer can be eliminated.

Further, the polyurethane layer 12 gives a nice touch, and provides a good shock-absorbing effect. Therefore, using the racket to play the ball game for a certain length of time does not cause pain or injury to the user's hand. Further, the base layer 11, which has a high tensile strength and low extensibility than the polyurethane layer, makes up for insufficiency of tensile strength of the strip 10, improving the whole tensile strength of the strip. Because the base layer is impregnated with resin, it has a solid and strong structure superior to the prior art design.

1. A strip for winding around a handle, said strip comprising:
a base layer made of a resin-impregnated cloth and having a top surface; and
a polyurethane layer bonded to said top surface of the base layer.

2. The strip as claimed in claim 1, wherein said resin-impregnated cloth is formed of a cloth dipped in polyurethane resin.

3. The strip as claimed in claim 1, wherein said resin-impregnated cloth is formed of a cloth dipped in acrylic resin.

4. The strip as claimed in claim 1, further comprising a bonding layer attached to a bottom surface of said base layer.

5. The strip as claimed in claim 4, wherein said bonding layer is an adhesive tape.
